(19) United States
(12) Patent Application Publication
(10) Pub. No.: US 2009/0246588 A1
(43) Pub. Date: Oct. 1, 2009

(54) Planar fuel cell device

(75) Inventors: Tsan-Fu Tseng, Hsinchu (TW); Jung-Chi Chen, Hsinchu (TW)

Correspondence Address: BACON & THOMAS, PLLC, 625 SLATERS LANE, FOURTH FLOOR, ALEXANDRIA, VA, 22314-1176, US

(73) Assignee: Coretronic Corporation, Hsin-Chu (TW)

(21) Appl. No.: 12/385,897

(22) Filed: Apr. 23, 2009

(30) Foreign Application Priority Data
Mar. 29, 2008 (TW) 097119792

(51) Int. Cl. H01M 8/10; H01M 8/04

(52) U.S. Cl. 429/30; 429/34

(57) ABSTRACT

A planar fuel cell device including a fuel cell module, a first cathode channel plate, a second cathode channel plate, and a fixing structure is provided. The first cathode channel plate is adapted to be disposed on a first surface of the fuel cell module and includes a first curved surface and a first channel structure disposed on the first curved surface. The first curved surface protrudes toward the fuel cell module for pressing the first surface of the fuel cell module. The second cathode channel plate is adapted to be disposed on a second surface of the fuel cell module opposite to the first surface. The fixing structure is adapted to be disposed on the edge of the fuel cell module for fixing the first cathode channel plate and the second cathode channel plate on the first surface and the second surface respectively.

### BACKGROUND OF THE INVENTION

(1) Field of the Invention

This invention relates to a fuel cell device, and more particularly relates to a planar proton exchange membrane fuel cell (PEMFC) device.

(2) Description of the Prior Art

Energy is indispensable to people's daily life. However, environmental damage due to exploitation and usage increases day by day. The development of green energy has already been the current trend. The energy generated by the fuel cell meets this trend due to its advantages of high efficiency, low noise and no pollution. In present, there are many kinds of fuel cells, proton exchange membrane fuel cell (PEMFC) and direct-methanol fuel cell (DMFC) are most common among the fuel cells.

FIGS. 1A and 1B are schematic views of a typical planar proton exchange membrane fuel cell device 10 before and after assembly. As FIG. 1A shows, the planar fuel cell device 10 includes a fuel cell module 100, a first cathode channel plate 12, a second cathode channel plate 14, and a screw 16 together with a nut 18 for assembling the above mentioned components. The fuel cell module 100 is used to generate power. The first cathode channel plate 12 and the second cathode channel plate 14 are used to exhaust gas and liquid generated during the operation of the fuel cell module 100. The screw 16 and the nut 18 are disposed on the edges of the planar fuel cell device 10 for fixing the first cathode channel plate 12 and the second cathode channel plate 14 on the upper surface and the lower surface of the fuel cell module 100 respectively.

FIG. 2 is a cross-section view of the fuel cell module 100 in FIG. 1A. As shown, the fuel cell module 100 includes an anode channel plate 120, two anode current collection plates 130, two membrane electrode assemblies (MEAs) 150, and two cathode current collection plates 190 from the central area to the outermost. The upper surface and the lower surface of the fuel cell module 100 are substantially symmetrical. The MEA 150 includes a proton exchange membrane (PEM), two catalyst layers at both surfaces of the PEM and two diffusion layers at both outermost surfaces. The anode current collection plate 130, the MEA 150, and the cathode current collection plate 190 are usually disposed on a printed circuit board (PCB) 140 by hot press adhesion so as to facilitate packaging process of the fuel cell module 100. Moreover, a plurality of openings 142 is fabricated in the central area of the PCB 140 as the entries and exits of gas and liquid during the operation of the fuel cell device 10. Because of these openings 142, the strength of the central area of the PCB 140 is weaker than the strength of the peripheral area of the PCB 140.

As FIG. 1B shows, when the first cathode channel plate 12 and the second cathode channel plate 14 are disposed on the upper surface and the lower surface of the fuel cell module 100, the peripheral area of the fuel cell module 100 is tightly pressed by the screw 16 and the nut 18. At the same time, the strength of the central area of the PCB 140 is weaker than the strength of the peripheral area of the PCB 140, as FIG. 1B shows, after the fuel cell module 100 is disposed on the PCB 140, the compression ratio of the central area of the fuel cell module 100 and the compression ratio of the peripheral area of the fuel cell module 100 would be different and a convex surface would be formed in the central area of the fuel cell module 100.

Noticeably, the contact surface of the first cathode channel plate 12 facing the fuel cell module 100 and the contact surface of the second cathode channel plate 14 facing the fuel cell module 100 are flat planes. As FIG. 1B shows, when the first cathode channel plate 12 and the second cathode channel plate 14 are fixed to the upper surface and the lower surface of the fuel cell module 100 respectively, the parts of the first cathode channel plate 12 and the second cathode channel plate 14 corresponding to the central area of the fuel cell module 100 are bended and even separated from the central area of the fuel cell module 100. Hence, the problem of non-uniform compression ratio in the fuel cell module 100 remains. In addition, the departure of the central area of the fuel cell module 100 from the first cathode channel plate 12 and the second cathode channel plate 14 causes variation of gas flow and liquid flow over the central area of the fuel cell module 100 so as to decrease power generation efficiency and shorten life of the fuel cell device 10.

Hence, how to solve the problem of compression ratio variation between the central area and the peripheral area of the fuel cell module 100 to enhance power generation efficiency is a problem desired to be solved for the fuel cell industry.

### SUMMARY OF THE INVENTION

The present invention provides a planar fuel cell and may solve the problem of compression ratio variation between the central area and the peripheral area of the fuel cell module so as to enhance power generation efficiency.

Other advantages of the present invention should be further indicated by the disclosures of the present invention.

To achieve one of, a part of or all of the above-mentioned advantages, or to achieve other advantages, an embodiment of the present invention provides a planar fuel cell device including a fuel cell module, a first cathode channel plate, a second cathode channel plate, and a fixing structure is provided. The first cathode channel plate is disposed on a first surface of the fuel cell module. The first cathode channel plate includes a first curved surface and a first channel structure disposed on the first curved surface. The first curved surface protruding toward the fuel cell module is for pressing the first surface of the fuel cell module. The second cathode channel plate is disposed on a second surface of the fuel cell module, and the second surface of the fuel cell module is opposite to the first surface of the fuel cell module. The fixing structure is disposed on the edge of the fuel cell module for fixing the first cathode channel plate and the second cathode channel plate on the first surface and the second surface of the fuel cell module respectively.

In an embodiment of the present invention, the second cathode channel plate and the first cathode channel plate are substantially symmetrical.

Because the first cathode channel plate of the embodiment of the present invention has a curved surface protruding toward the fuel cell module, the first cathode channel plate may press the surface of the fuel cell module while the central area of the fuel cell module forms a convex surface generated by a chemical reaction of the fuel cell module after the planar fuel cell assembling. Meanwhile, the first curved surface and the first channel structure may press the central area of the fuel cell module so as to keep the compression ratio of the central area and the peripheral area consistent to increase power generation efficiency of the fuel cell module and extend life of the fuel cell device.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The present invention will now be specified with reference to its preferred embodiment illustrated in the drawings, in which

FIGS. 1A and 1B are schematic views of a typical planar fuel cell device before and after assembling;

FIG. 2 is a schematic view of a typical fuel cell module;

FIG. 3 is a schematic view of a planar fuel cell device of an embodiment of the present invention before assembling; and

FIG. 4 is a schematic view of the planar fuel cell device in FIG. 3 after assembling.

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

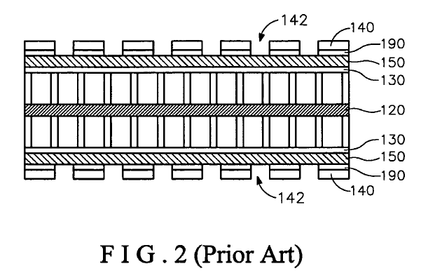

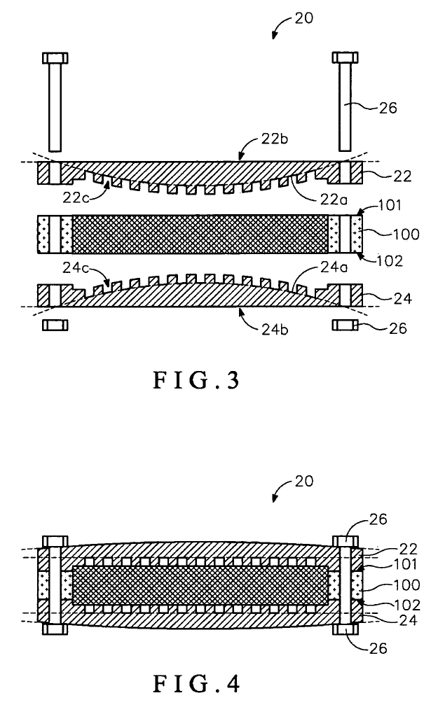

FIG. 3 is a schematic cross-section view of an embodiment of the components of a planar fuel cell device 20 according to the present invention before assembling. As FIG. 3 shows, these components are used to assemble the planar fuel cell device 20. The planar fuel cell device 20 includes a fuel cell module 100, a first cathode channel plate 22, a second cathode channel plate 24, and a fixing structure 26. The first cathode channel plate 22 is disposed on a first surface 101 of the fuel cell module 100. The second cathode channel plate 24 is disposed on a second surface 102 of the fuel cell module 100 opposite to the first surface 101. The fixing structure 26 is used to fix the first cathode channel plate 22 and the second cathode channel plate 24 on the first surface 101 and the second surface 102 of the fuel cell module 100 respectively. Noticeably, a conventional fuel cell module 100 as shown in FIG.2 may be adapted to the planar fuel cell device 20 in this embodiment. However, the present invention is not so limited. Other kinds of planar PEMFC modules having the MEA 150 adhesive to the PCB 140 are also adapted to the embodiment of the present invention.

Referring to FIG. 3, the first cathode channel plate 22 of the embodiment includes a first curved surface 22a and a first channel structure 22c disposed on the first curved surface 22a. The first curved surface 22a may protrude toward the fuel cell module 100 for pressing the first surface 101 of the fuel cell module 100. The second cathode channel plate 24 includes a second curved surface 24a and a second channel structure 24c disposed on the second curved surface 24a. The second curved surface 24a may protrude toward the fuel cell module 100 for pressing the second surface 102 of the fuel cell module 100. For an embodiment, the surface of the first cathode channel plate 22 opposite to the first curved surface 22a is a flat surface 22b, and the surface of the second cathode channel plate 24 opposite to the second curved surface 24a is also a flat surface 24b. Because the surfaces protruding toward the fuel cell module 100 of the first cathode channel plate 22 and the first cathode channel plate 24 are convex curved surfaces 22a and 24a, in the central portions of the first cathode channel plate 22 and the second cathode channel plate 24, the thicknesses of the first cathode channel plate 22 and the second cathode channel plate 24 show a tendency of increasing from the peripheral area to the central area. That is, the first cathode channel plate 22 and the second cathode channel plate 24 are thicker near the central area and thinner at the peripheral area. The strength of the first cathode channel plate 22 and the second cathode channel plate 24 are stronger close to the central area and weaker at the peripheral area. Thus, when the first cathode channel plate 22 and the second cathode channel plate 24 are fixed to the first surface 101 and the second surface 102 of the fuel cell module 100, respectively, the central portion of the first cathode channel plate 22 and the second cathode channel plate 24 are difficult to deform. Accordingly, the curved surface 22a of the first cathode channel plate 22 and the curved surfaces 24a of the second cathode channel plate 24 may press the central area of the fuel cell module 100 effectively.

In above embodiments, the surface of the first cathode channel plate 22 opposite to the first curved surface 22a and the surface of the second cathode channel plate 24 opposite to the second curved surface 24a are both flat surfaces 22b,24b. However, the present invention is not so limited. The surface of the first cathode channel plate 22 opposite to the first curved surface 22a and the surface of the second cathode channel plate 24 opposite to the second curved surface 24a may be inward curved or outward curved, only if the first cathode channel plate 22 and the second cathode channel plate 24 is thicker near the central area and thinner near the peripheral area.

As FIG. 3 shows, because the central portion of the first cathode channel plate 22 is difficult to deform, the first curved surface 22a of the first cathode channel plate 22 may provide more compression force to press the central area of the fuel cell module 100 so that the compression ratio of the central area and peripheral area of the fuel cell module 100 may be kept consistent. Furthermore, as FIG.4 shows, when the first cathode channel plate 22 is fixed to the upper surface of the fuel cell module 100, the first curved surface 22a may become a flat plane as the first cathode channel plate 22 is bended by forces to provide each portion of the first surface 101 of the fuel cell module 100 a applicable force and keep the compression ratio of the central area of the fuel cell module 100 and the peripheral area of the fuel cell module 100 consistent. In the same way, the second curved surface 24a of the second cathode channel plate 24 may be also conducive to keep the compression ratios of the central area and the peripheral area of the fuel cell module 100 consistent.

In addition, as FIG. 3 shows, the first channel structure 22c disposed on the first curved surface 22a of the first cathode channel plate 22 is used to exhaust gas and liquid generated by the chemical reaction of the fuel cell module 100. The second channel structure 24c disposed on the second curved surface 24a of the second cathode channel plate 24 is also used to exhaust gas and liquid generated by the chemical reaction of the fuel cell module 100. For an embodiment, the first channel structure 22c of the first cathode channel plate 22 has a plurality of channels uniformly distributed on the first curved surface 22a to keep gas flow and liquid flow through the MEA 150 of the fuel cell module 100 consistent so as to increase power generation efficiency. The second channel structure 24c of the second cathode channel plate 24 also has a plurality of channels uniformly distributed on the second curved surface 24a. Moreover, each channel of the first cathode channel plate 22 has substantially the same depth relative to the first curved surface 22a and substantially the same cross-section area. Each channel of the second cathode channel plate 24 has substantially the same depth relative to the second curved surface 24a.

The first cathode channel plate 22 and the second cathode channel plate 24 in the embodiment of the present invention may be made of metal in the way of machining or casting, non-metal in the way of powder metallurgy, or polymeric material in the way of injection molding.

As FIG. 3 shows, the fixing structure 26 is disposed on the edges of the planar fuel cell device 20 for fixing the first cathode channel plate 22 and the second cathode channel plate 24 on the first surface 101 and the second surface 102 of the fuel cell module 100 respectively. For an embodiment, the fixing structure 26 includes at least two sets of components symmetrically distributed at two opposite surface of the central area of the fuel cell module 100. Each of the sets of components has a screw and a nut for fixing the first cathode channel plate 22 and the second cathode channel plate 24 on the first surface 101 and the second surface 102 of the fuel cell module 100 respectively for pressing the central area of the fuel cell module 100. Noticeably, in this embodiment, the first surface 101 and the second surface 102 of the fuel cell module 100 are symmetrical. The shapes of first cathode channel plate 22 and the second cathode channel plate 24 are substantially symmetrical. The first cathode channel plate 22 and the second cathode channel plate 24 provide similar force to the fuel cell module 100 to keep the compression ratio of each portion of the fuel cell module 100 consistent.

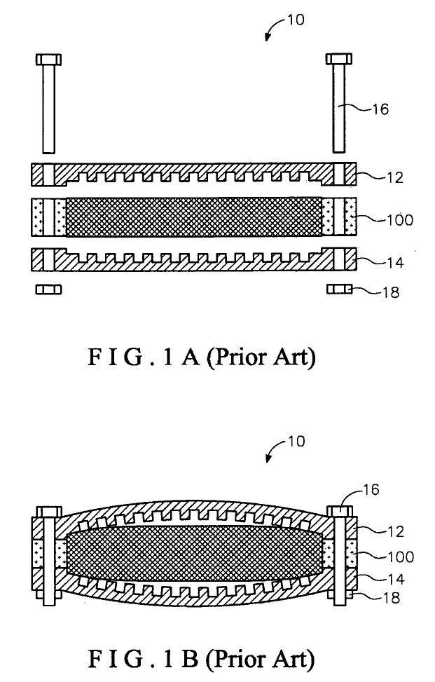

As FIG. 1B shows, the central area of the conventional fuel cell module 100 forms a convex because of chemical reactions so as to result in the variation of compression ratio of the central area and the peripheral area of the fuel cell module 100 while the cathode channel plates 12, 14 pressing MEA 150 and affect the power generation efficiency. In addition, since the contact surfaces of the conventional cathode channel plates 12,14 facing the fuel cell module 100 are designed to be flat planes, the central portions of the cathode channel plates 12,14 are bended and even separated from the central area of the fuel cell module 100 when the cathode channel plates 12,14 are fixed to the upper surface and the lower surface of the fuel cell module 100, respectively. In comparison, as FIG. 4 shows, the strength of the cathode channel plates 22,24 is stronger in the central area and weaker in the peripheral area. In addition, the cathode channel plates 22,24 have the curved surfaces 22a,24a protruding toward the fuel cell module 100 to make the cathode channel plates 22,24 tightly contact the fuel cell module 100 and keep the compression ratio of the central area and the peripheral area of the fuel cell module consistent to increase power generation efficiency. In addition, in the embodiment of the present invention, the curved surfaces 22a, 24a of the cathode channel plates 22,24 may protrude toward the fuel cell module 100, and there are specific channel structures 22c,24c disposed along the curved surfaces 22a,24a. Thus, when the cathode channel plates 22,24 are fixed to the upper surface and the lower surface of the fuel cell module 100, the channels of the channel structures 22c,24c of the cathode channel plates 22,24 with the same cross-section area may keep gas flow and liquid flow uniformly distributed over the whole cathode channel plates 22,24 so as to increase power generation efficiency and extend life of the fuel cell device 20.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A planar fuel cell device, comprising:
a fuel cell module;
a first cathode channel plate, adapted to be disposed on a first surface of the fuel cell module, and the first cathode channel plate comprising a first curved surface and a first channel structure disposed on the first curved surface, wherein the first curved surface is capable of protruding toward the fuel cell module for pressing the first surface of the fuel cell module;
a second cathode channel plate, adapted to be disposed on a second surface of the fuel cell module, and the second surface being opposite to the first surface; and
a fixing structure, adapted to be disposed on the edge of the fuel cell module for fixing the first cathode channel plate on the first surface of the fuel cell module and fixing the second cathode channel plate on the second surface of the fuel cell module.

2. The planar fuel cell device of claim 1, wherein the fuel cell module is a proton exchange membrane fuel cell module.

3. The planar fuel cell device of claim 1, wherein the second cathode channel plate comprises a second curved surface and a second channel structure disposed on the second curved surface, and the second curved surface of the second cathode channel plate is capable of protruding toward the fuel cell module for pressing the second surface of the fuel cell module.

4. The planar fuel cell device of claim 3, wherein the second cathode channel plate and the first cathode channel plate are substantially symmetrical.

5. The planar fuel cell device of claim 1, wherein the first channel structure of the first cathode channel plate comprises a plurality of channels with substantially the same depth relative to the first curved surface.

6. The planar fuel cell device of claim 1, wherein the fixing structure is adapted for fixing the first cathode channel plate and the second cathode channel plate to the fuel cell module.

7. The planar fuel cell device of claim 1, wherein the fixing structure comprises at least two sets of components adapted to be symmetrically distributed at two opposite surfaces of the central area of the fuel cell module, and each of the sets of components comprises a screw and a nut.

8. The planar fuel cell device of claim 1, wherein thickness of the first cathode channel plate is capable of increasing from the peripheral area of the first cathode channel plate to the central area of the first cathode channel plate.

9. The planar fuel cell device of claim 1, wherein a surface of the first cathode channel plate opposite to the first curved surface is a flat surface.
